(19) United States
(12) Patent Application Publication
(10) Pub. No.: US 2013/0244000 A1
(43) Pub. Date: Sep. 19, 2013

(54) HIGHLY ADHESIVE POLYIMIDE COPPER CLAD LAMINATE AND METHOD OF MAKING THE SAME

(71) Applicants: Yu-Jean Chen, Zhudong Town (TW); Brian C. Auman, Avondale, PA (US); Sheng-Yu Huang, Sanchong City (TW); Tsutomu Mutoh, Tochigi (JP); Ming-Te We, Hukuo Shiang (TW); Yu-Chih Yeh, Zhongli City (TW)

(72) Inventors: Yu-Jean Chen, Zhudong Town (TW); Brian C. Auman, Avondale, PA (US); Sheng-Yu Huang, Sanchong City (TW); Tsutomu Mutoh, Tochigi (JP); Ming-Te We, Hukuo Shiang (TW); Yu-Chih Yeh, Zhongli City (TW)

(73) Assignee: E I DU PONT DE NEMOURS AND COMPANY, Wilmington, DE (US)

(21) Appl. No.: 13/602,966

(22) Filed: Sep. 4, 2012

Related U.S. Application Data
(63) Continuation-in-part of application No. 12/865,746, filed on Aug. 2, 2010, now abandoned.

(30) Foreign Application Priority Data
Feb. 5, 2008 (TW) 097104940

(51) Int. Cl. B32B 3/30

(52) U.S. Cl. CPC B32B 3/30
USPC 428/141; 427/379

(57) ABSTRACT

The present invention is related to a chip on film package, comprising a polyimide copper clad laminate and the process of making the same. The laminate comprises a layer of polyimide and a layer of copper foil, wherein the polyimide layer is made from a polyimide precursor comprising a diamine monomer, a dianhydride monomer, an organic solvent and a silane coupling agent having one or more organic functional groups, and the copper foil is a smooth copper foil. The polyimide layer of the present invention provides high transparency, good dimensional stability, good mechanical properties and good adhesion to the copper foil.

This is a continuation-in part of U.S. patent application Ser. No. 12/865,746, the disclosure of which is hereby incorporated into this specification by reference.

### BACKGROUND OF THE INVENTION

1. Technical Field

The present invention is related to a polyimide copper clad laminate which is particularly useful in chip-on-film (COF) technique or flexible copper clad laminate (FCCL).

2. Prior Art

COF (Chip on Film, or Chip on Flex) is a technique of connecting a chip with a flexible circuit board by using a flexible substrate as a packaging carrier. Generally, a COF defined in a broad sense refers to techniques including tape automated bonding (TAB), flexible circuit broad manufacturing and COF technique in a narrow sense which particularly refers to a technique for packaging driver integrated circuits (ICs) for large display panels. The “COF” in the present invention refers to the definition in the broad sense and particularly refers to COF for packaging and flexible circuit board.

Tape carrier package (TCP) and COF are currently two major techniques for packaging LCD driver ICs. COF evolved from TCP technique and was developed for fine pitch process. Generally, to reduce the cost, TCP technique, which has higher technology maturity, is chosen for manufacturing low-level (low-resolution) display panels while COF is used in packaging driver ICs of high-level displays. Particularly, COF is more advantageous for packaging driver ICs with fine lines because it reduces the loss of display panels from scrapping due to connection failure

of driver ICs. Display panels are currently developed for large size and high resolution so COF becomes popular.

The materials used as packaging tapes in COF are normally polymers. Although polyesters and Teflon® have been developed in some techniques, polyimide is still the most common materials used in COF.

A polyimide metal clad laminate includes a dielectric layer of polyimide and at least a conductive layer of metal foil. The layers are bonded with or without adhesives. The metal foil is normally a copper foil.

A polyimide copper clad laminate can be used as a flexible copper clad laminate (FCCL). Recently, due to the widespread use of mobile telecommunication products and portable electronic devices, circuit boards manufacturing is moving toward the direction of high density, light weight and high efficiency. Conventional printed circuit boards, which cannot be bent and therefore cannot efficiently fit in limited space of an electronic product, are gradually replaced with flexible circuit boards. However, a material for flexible circuit boards is difficult to find because it has to satisfy several requirements at the same time. Because polyimide meets the requirements for mechanical properties, flexibility, solvent resistance, dielectric property, thermal resistance, etc., it has been widely used in the field of flexible circuit boards.

However, commercial polyimide copper clad laminates still encounter the following problems:
(1) Poor adhesion between polyimide layer and metal foil. The polyimide layer must tightly bond to the metal foil in either the application of COF or FCCL. During the process for manufacturing flexible circuit boards, especially during the step of etching or welding, stress will be generated and this will cause severe damage due to the deformation or peeling of the laminate.
(2) Because the laminate has at least two layers, the coefficient of thermal expansion (CTE) of each layer might be different. In a high-temperature downstream process or operation environment, the structure of the laminate will be damaged due to dimensional instability if the CTE of the adhesive layer is significantly mismatched. This will decrease the reliability of the product.
(3) Normally, a polyimide laminate, once manufactured, will be connected to other devices to produce final products. If a polyimide laminate has low transparency, it may increase the technical difficulty in a downstream process in which an optical alignment is applied, and cause flaws due to connection failure.

Some prior art references attempted to provide solutions to part of the problems stated above. However, none of the references can solve all of the problems. For example, a filler is normally added to polyimide in order to improve its mechanical properties, CTE and dimensional stability but most conventional fillers will seriously impact the substrate clarity, which results in some inconvenience to an optical alignment or inspection in a downstream process. Likewise, one can increase the chain rigidity (rod-like character) of the polyimide backbone in order to achieve desired CTE and improved dimensional stability, but often these very stiff, rod like polyimide backbones have insufficient adhesion to copper or other metal foils, particularly foils with low surface roughness. While one can utilize metal foils with increased surface roughness to improve adhesion between the metal foil and the polyimide, this again has the disadvantage of causing decreased surface smoothness on the polyimide when the metal foil is removed or patterned and thus reducing the polyimide's clarity for optical alignment or inspection techniques. In addition, even if these surface treatments are utilized, desired adhesion can be hardly reached.

Some relevant references attempting to solve part of the problems are described below. One should notice that none of these references provide a solution to all the problems.

JP 63-267542 discloses a multilayer metal laminate, wherein a silane coupling agent is added to the resin layer (adhesive layer) contacting the metal layer to improve the adhesion. However, the CTEs of the layers in the multilayer structure are different, which results in dimensional instability. In addition, the adhesive layer has poor thermal resistance so it cannot undergo a high-temperature downstream process.

JP 04-023879 discloses a triple-layer metal laminate in which an adhesive layer is disposed in the middle to increase adhesion. The laminate is laminated by low-temperature pressing so as to avoid damage from high temperature. Nevertheless, the adhesion is poor.

JP 07-094834 discloses a flexible printed circuit board. To improve adhesion, a diamine monomer containing a Si—O group is used and a silane coupling agent is blended in the polyimide layer. However, the silane coupling agent used therein may make polyimide precursor unstable and is not suitable for directly mixing in polyimide precursor.

JP 2006-007632 discloses a triple-layer flexible polyimide metal clad laminate. A thermal-resistive adhesive layer is disposed between the polyimide layer and the metal layer and a silane coupling agent is added to the adhesive layer to improve the adhesion between the polyimide layer and the metal layer. However, the CTEs of the layers are different, which results in dimensional instability and makes it difficult to be further processed.

To solve the problems indicated above, the present invention provides a polyimide laminate comprising a silane coupling agent. The laminate of the present invention does not contain any intermediate adhesive layer, and the polyimide layer combines the benefits of strong adhesion to a copper foil of low surface roughness, high transparency, good mechanical properties, and satisfactory dimensional and thermal stability. The present invention meets the commercial need at present and in the future.

### DETAILED DESCRIPTION OF THE INVENTION

To meet the commercial needs, one object of the present invention is to provide a polyimide laminate containing a silane coupling agent. The polyimide laminate comprises:

a polyimide layer containing a silane coupling agent and a layer of copper foil, wherein the polyimide layer is formed from a precursor comprising a diamine monomer, a dianhydride monomer, an organic solvent and a silane coupling agent having one or more organic functional groups; and the copper foil has a surface roughness of less than 0.7 μm.

To increase the adhesion between the polyimide layer and the copper foil, a specific silane coupling agent, as an adhesion promoter, is directly incorporated into the polyimide precursor coating solution. For utilization in this way, the silane coupling agent must be carefully chosen so that it enhances the adhesion of the copper foil to the polyimide layer in its final cured state while not significantly degrading the properties (e.g., molecular weight, viscosity, stability) of the precursor coating solution. To this end, the silane coupling agent should generally have an organic functional group that can interact well with the polyimide (e.g., via hydrogen bonding) but does not directly react with the polyimide precursor. From this standpoint, typical primary, and to a lesser extent secondary, amino functional silanes (e.g., gamma-aminopropyltriethoxy silane) which are often used with polyimides are not preferred since they can directly react with the backbone of the polymeric precursor (e.g., via salt formation with the carboxylic acid groups of the polymeric precursor, or displacement of the aromatic amine from the polymeric precursor having amide linkage) resulting in viscosity instability and/or loss of polymer molecular weight.

Silane coupling agents are well known to a person skilled in the art. Suitable silane coupling agent for the present invention is represented by the following formula:

Y—R′—Si(OR)₃
wherein Y is a functional group selected from the group consisting of: urea, and carbamate;
R′ is ethyl, propyl, or phenyl substituted by ethyl or propyl wherein the phenyl ring is attached to Y, or a bond;
R is methyl, ethyl or other linear or branched C₃₋₆alkyl.

Preferred silane coupling agents for the present invention contain urea or carbamate group. Most preferred silane coupling agents are gamma-ureidopropyltrimethoxy silane or gamma-ureidopropyltriethoxy silane.

The monomers forming the backbone of the polyimide are chosen in such a way as to ensure that the CTE of the polyimide precursor at final cured state is close to the CTE of the metal, especially that of copper. A polyimide metal clad laminate of good dimensional stability can be obtained by casting, drying and curing the selected polyimide precursor on the metal foil.

The diamine monomer of the present invention can be selected from any diamine compound which is known to be suitable for polymerizing a polyimide and is represented as:

H₂N—Ar₁—NH₂

wherein Ar₁ is selected from the group consisting of the following:

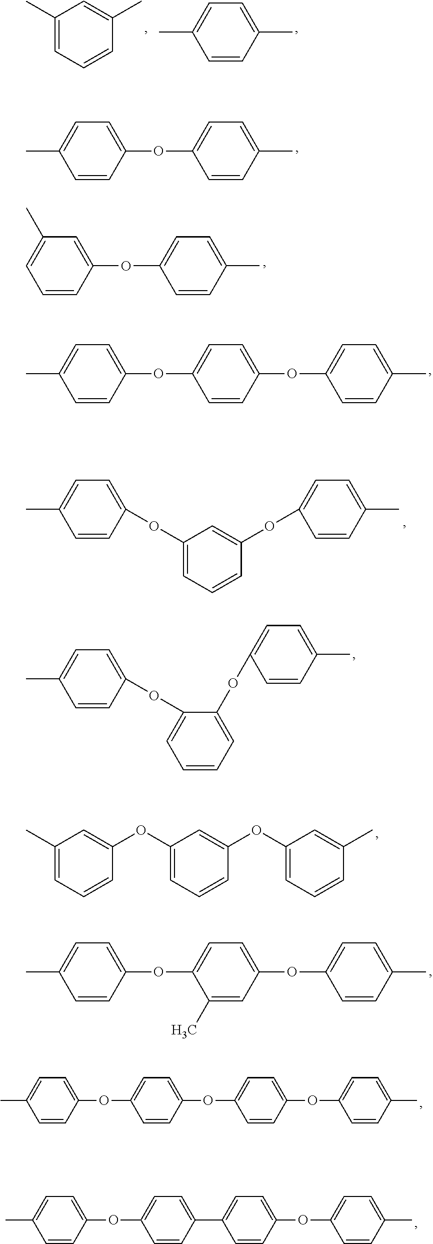

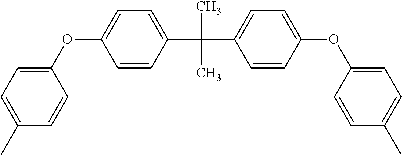 [SMILES: Cc1ccc(Oc2ccc(C(C)(C)c3ccc(Oc4ccc(C)cc4)cc3)cc2)cc1]

and the like and a combination thereof.
That is, the diamine monomer is selected from the group consisting of m-phenylenediamine (m-PDA; MPD), p-phenylenediamine, (p-PDA; PPD), 4,4′-oxydianiline (4,4′-ODA), 3,4′-oxydianiline (3,4′-ODA), 1,4-bis(4-aminophenoxy)benzene (1,4-APB; APB-144), 1,3-bis(4-aminophenoxy)benzene (1,3-APB; APB-134), 1,2-bis(4-aminophenoxy)benzene (1,2-APB; APB-124), 1,3-bis(3-aminophenoxy)benzene (APB-133), 2,5-bis(4-aminophenoxy)toluene, bis[4-(4-aminophenoxy)phenyl]ether (BAPE), 4,4′-bis[4-aminophenoxy]biphenyl (BAPB), 2,2-bis[4-(4-aminophenoxy)]phenyl propane; (BAPP)

and the like and a combination thereof.

Preferred diamine monomer is selected from 4,4′-ODA, p-PDA or the combination thereof.

In one embodiment of the present invention, p-PDA is 40 to 99 mol % of total diamine monomers, preferably 60 to 97 mol %, most preferably 80 to 95 mol %.

The dianhydride monomer of the present invention can be selected from any conventional dianhydride which is suitable for polymerizing a polyimide and can be represented as:

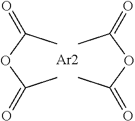

wherein Ar₂ is selected from the group consisting of the following:

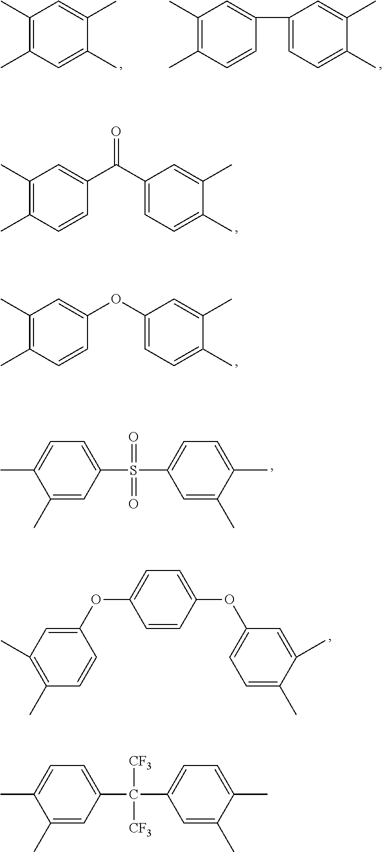

and the like and a combination thereof.
That is, the dianhydride monomer is selected from the group consisting of pyromellitic dianhydride (PMDA), 4,4′-biphenyltetracarboxylic dianhydride (BPDA), benzophenonetetracarboxylic dianhydride (BTDA), oxydiphthalic dianhydride (ODPA), diohenyl sulfonetetracarboxylic dianhydride (DSDA), 1,4-bis(3,4-dicarboxyphenoxy)benzene dianhydride (HQDEA), 4,4′-[hexafluoroisopropylidene]diphthalic anhydride (6FDA) and the like and a combination thereof.

Preferred dianhydride is selected from BPDA, BTDA or the combination thereof.

In one embodiment of the present invention, the dianhydride monomer is BPDA or the combination of BTDA and BPDA, wherein BPDA is from 30 to 100 mol % of the total dianhydride monomers, preferably 50 to 99 mol %, most preferably 60 to 90 mol %.

The organic solvent in the polyimide precursor can be selected from any solvent which can uniformly disperse diamine monomers and dianhydride monomers.

Preferred solvent is selected from N-methyl-2-Pyrrolidone (NMP), dimethyl acetamide (DMAc), demethyl sulfoxide (DMSO), dimethyl formamide (DMF) or cresol.

In one embodiment of the present invention, the solvent in the polyimide precursor is selected from NMP or DMAc.

The skill of choosing the ratio of diamine monomers to dianhydride monomers in the polyimide precursor of the present invention is known and a person having ordinary skill in the art can easily find an optimal ratio by the aids of references (for example, the disclosure in Taiwan Patent No. TW 220901) and optimization procedures.

The suitable proportion of the silane coupling agent in the polyimide precursor of the present invention is in an amount of 1 wt % or less of the total weight of the polyimide precursor, preferably from 0.05 to 0.7 wt %, most preferably 0.05 to 0.5 wt %.

Fillers can be optionally incorporated into the polyimide precursor of the present invention. Fillers can be selected from powders of talc, mica, calcium carbonate, calcium phosphate, calcium silicate or silica. But the incorporation of the fillers above results in reduction of the transparency of the polyimide layer unless the fillers are in a very low amount or of very small particle size.

In one embodiment of the present invention, no filler or additive other than the silane coupling agent is incorporated into the polyimide precursor whereby a polyimide laminate with high transparency is produced.

One object of the present invention is to provide a process for manufacturing a polyimide precursor, which includes selecting a suitable solvent, adding suitable diamine monomers, stirring for several hours (generally 1 to 3 hrs) at 70° C. or less, and then adding dianhydride monomers and stirring to produce a reaction until high viscosity is reached, and then adding a suitable silane coupling agent, stirring for several hours (normally 4 to 12 hrs).

Another object of the present invention is to provide a process for manufacturing a polyimide laminate. Firstly, polyimide precursor of the present invention is provided. Then, the polyimide precursor is cast onto a metal substrate and baked, in batch or continuously, at high temperature to cure the polyimide precursor so as to obtain the polyimide laminate. Generally, the baking is at a temperature from 250° C. to 450° C.

Another object of the present invention is to provide a polyimide copper clad laminate for COF packaging technique. The polyimide copper clad laminate comprises a polyimide layer and at least one copper foil. The copper foil is chosen so that the surface roughness of the foil has minimal impact on the clarity (minimal light scattering due to surface topography) of the polyimide substrate. Normally, the selected copper foil has a surface roughness of 0.7 μm or less and such copper foil is referred to as “smooth copper foil.”

Another object of the present invention is to provide a flexible copper clad laminate (FCCL) which comprises a polyimide layer of the present invention and at least one copper foil.

### EXAMPLES

The following examples further illustrate but do not limit the embodiments of the present invention. A person skilled in the art will recognize that any modification or adjustment which can be easily accomplished by a skilled person is encompassed in the scope of the present invention.

### General Procedure

The polyimide copper clad laminate of the present invention can be prepared by any process known to a person skilled in the art. The steps include adding diamine monomers, dianhydride monomers and a silane coupling agent into a solvent and mixing and stirring at a certain temperature to obtain a polyimide precursor. The polyimide precursor was cast on a copper foil. The precursor was baked and cured and a polyimide copper clad laminate was obtained.

### Examples

### Comparative Example 1

ODA (3.44 g) and p-PDA (10.52 g) were put in a stirring NMP-EG (282.4 g) until completely dissolved. BTDA (4.05 g) was put in to initiate the reaction. After about 1 hr, BPDA (29.89 g) was put in the solution. After 2 hrs, a clear polyimide precursor of high viscosity (viscosity is about 45000 cps) was obtained. After 2 hrs of deaeration, the polyimide precursor was coated onto a copper foil having low surface roughness (0.6 μm) and a thickness of 15 μm. After the precursor was baked and cured, a polyimide copper clad laminate was obtained.

### Example 1

ODA (3.44 g) and p-PDA (10.52 g) were put in a stirring NMP-EG (282.4 g) and after completely dissolution, BTDA (4.05 g) was put in and the reaction began. After about 1 hr, BPDA (29.89 g) was put in the solution. After 2 hrs, a clear polyimide precursor with high viscosity (viscosity is about 45000 cps) was obtained.

Gamma-ureidopropyltriethoxy silane (0.86 g) was added and the polyimide precursor was stirred for 4 hrs. After 2 hrs deaeration, the polyimide precursor was coated onto a copper foil having low surface roughness (0.6 μm) and a thickness of 15 μm. After the precursor was baked and cured, a polyimide copper clad laminate was obtained.

### Example 2

It was prepared by a process similar to Example 1.

Test Conditions:

1. Peeling strength test: IPC-TM 650-2.4.9ₒ

2. Dimensional stability: IPC-TM 650-2.2.4ₒ

TABLE 1

| | Comparative | Example | Example |
|---|---|---|---|
| | example | 1 | 2 |
| copper foil thickness | 15 | 15 | 15 |
| (μm) | | | |
| surface roughness Rz | 0.6 | 0.6 | 0.6 |
| (μm) | | | |
| silane coupling agent* | — | A | B |
| Peeling Strength | 0.9 | 1.4 | 0.9 |
| (Kgf/cm) | | | |
| DimStab-thermal (%) | −0.030 | 0.001 | −0.037 |
| DimStab-normal (%) | 0.009 | 0.013 | 0.004 |

*A: gamma-ureidopropyltriethoxy silane
B: phenylaminopropyltrimethoxy silane

It can be observed from TABLE 1 that the peeling strength between the copper foil and the polyimide layer of Example 1, which utilizes a silane coupling agent of the present invention, is significantly increased while the dimensional stability is maintained.

In addition, although Example 2 utilizes a silane coupling agent commonly used in the art, the peeling strength between the smooth copper foil and polyimide is not increased.

What is claimed is:

1. A chip on film (“COF”) package, comprising
a polyimide copper clad laminate comprising a layer of polyimide and at least one layer of copper foil, wherein
the polyimide layer is formed from a diamine monomer, a dianhydride monomer, an organic solvent and a silane coupling agent having one or more organic functional groups,
wherein the copper foil has a surface roughness of 0.7 μm or less,
wherein the silane coupling agent is represented by the following formula:
Y—R′—Si(OR)₃,
wherein Y is selected from the group consisting of:
urea and carbamate;
R′ is ethyl, propyl, or phenyl substituted by ethyl or propyl;
R is methyl, ethyl or other linear or branched C₃₋₆alkyl,
wherein the diamine monomer is selected from the group consisting of: m-phenylenediamine (m-PDA; MPD), p-phenylenediamine, (p-PDA; PPD), 4,4′-oxydianiline (4,4′-ODA), 3,4′-oxydianiline (3,4′-ODA), 1,4-bis(4-aminophenoxy)benzene (1,4-APB; APB-144), 1,3-bis(4-aminophenoxy)benzene (1,3-APB; APB-134), 1,2-bis(4-aminophenoxy)benzene (1,2-APB; APB-124), 1,3-bis(3-aminophenoxy)benzene (APB-133), 2,5-bis(4-aminophenoxy)toluene, bis[4-(4-aminophenoxy)phenyl]ether (BAPE), 4,4′-bis[4-aminophenoxy]biphenyl (BAPB), 2,2-bis[4-(4-aminophenoxy)]phenyl propane (BAPP) and a combination thereof,
wherein the dianhydride monomer is selected from the group consisting of: pyromellitic dianhydride (PMDA), 4,4′-biphenyltetracarboxylic dianhydride (BPDA), benzophenonetetracarboxylic dianhydride (BTDA), oxydiphthalic dianhydride (ODPA), diohenyl sulfonetetracarboxylic dianhydride (DSDA), 1,4-bis(3,4-dicarboxyphenoxy)benzene dianhydride (HQDEA), 4,4′-[hexafluoroisopropylidene]diphthalic anhydride (6FDA)
and a combination thereof.

2. The chip on film of claim 1, wherein the silane coupling agent has a functional group of urea.

3. The chip on film of claim 2, wherein the silane coupling agent is gamma-ureidopropyltrimethoxy silane or gamma-ureidopropyltriethoxy silane.

4. The chip on film of claim 1 wherein the solvent is selected from NMP, DMAc, DMSO, DMF or cresol.

5. The chip on film of claim 1, wherein the silane coupling agent is in an amount of no more than 1 wt % of the total weight of the polyimide.

6. The chip on film of claim 1, wherein the silane coupling agent is in an amount of from 0.05 to 0.7 wt % of the total weight of the polyimide.

7. The chip on film of claim 1, wherein no filler or additive other than a silane coupling agent is incorporated into the polyimide.

8. A process for manufacturing the chip on film of claim 1 comprising the steps of:
(a) providing a composition comprising a diamine monomer, a dihydride monomer and an organic solvent;
(b) heating the composition at 70° C. or less and stirring for a sufficient time to obtain a polyimide precursor;
(c) directly mixing the composition obtained with a silane coupling agent which has at least an organic functional group to obtain a polyimide precursor coating solution;
(d) coating the polyimide precursor onto a copper foil and baking; and
(e) heating the polyimide precursor at a temperature of 250° C. to 450° C. to cure the polyimide precursor so as to obtain the polyimide laminate.
